(19) United States
(12) Patent Application Publication
(10) Pub. No.: US 2025/0091553 A1
(43) Pub. Date: Mar. 20, 2025

(54) VEHICLE WASHING ASSEMBLY

(71) Applicant: Michael Bankay, Scarborough (CA)

(72) Inventor: Michael Bankay, Scarborough (CA)

(21) Appl. No.: 18/368,396

(22) Filed: Sep. 14, 2023

(51) Int. Cl. B60S 3/04; A47L 5/14; A47L 7/00; A47L 9/14; A47L 9/24; A47L 9/28; B60S 3/00

(52) U.S. Cl. CPC B60S 3/044; A47L 5/14; A47L 7/0076; A47L 7/009; A47L 9/149; A47L 9/24; A47L 9/2878; A47L 9/2884; B60S 3/008; B60S 3/047

(57) ABSTRACT

A vehicle washing assembly for washing, drying, and vacuuming a vehicle includes a housing having a base wall, a peripheral wall that is attached to and extends upwardly from the base wall, and a top wall that is attached to the peripheral wall opposite the base wall. The peripheral wall bounds an interior area. A pressure washer unit is mounted to the housing and configured to expel a fluid under pressure in a selected direction. A blower unit is mounted to the housing and configured to suction air inwardly through an inlet and to blow air outwardly through an outlet. Both the inlet and the outlet are mounted to the housing. A catch is in fluid communication with the inlet for capturing debris suctioned in through the inlet. A power supply is attached to the housing and is electrically coupled to the pressure washer unit and the blower unit.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to car wash devices and more particularly pertains to a new car wash device for washing, drying, and vacuuming a vehicle which is portable in nature for be moved as needed for vehicle washing purposes.

### (2) Description of Related Art Including Information Disclosed Under 37 CFR 1.97 and 1.98

The prior art relates to car wash devices. Some car wash devices direct fluid under pressure in a selected direction to wash dirt and grime from the car or vehicle. Other car wash devices comprise vacuums or blowers used to suction dirt from the vehicle or direct air under pressure for drying the vehicle. Other car wash devices comprise automated assemblies through which a vehicle can move while the exterior of the vehicle is cleaned by the automated assembly. However, there is a need in the art for a single device or assembly that can be used to spray, scrub, wash, vacuum, and dry a vehicle.

### BRIEF SUMMARY OF THE INVENTION

An embodiment of the disclosure meets the needs presented above by generally comprising a cleaning device for a vehicle. The cleaning device generally comprises with a housing having a base wall, a peripheral wall that is attached to and extends upwardly from the base wall, and a top wall that is attached to the peripheral wall opposite the base wall. The peripheral wall bounds an interior area. A pressure washer unit is mounted to the housing and configured to expel a fluid under pressure in a selected direction. In embodiments, the pressure washer unit can include a pump fluidly coupled to a hose with a high-pressure nozzle and a low-pressure nozzle. The high-pressure nozzle dispenses the fluid under a high pressure, and the low-pressure nozzle dispenses the fluid under a pressure that is less than the high pressure. With the high-pressure nozzle, the cleaning device can be used to break up tough soils and other substances like road grime, bird droppings, bugs, tree sap, or caked on mud that are on the vehicle. With the low-pressure nozzle, the cleaning device can be used to apply cleaning solution or rinse the vehicle after washing. A blower unit is mounted to the housing and configured to suction air inwardly through an inlet and to blow air outwardly through an outlet. Both the inlet and the outlet are mounted to the housing. A catch is in fluid communication with the inlet for capturing debris suctioned in through the inlet. A hose may be included that can couple to either the inlet or the outlet. When coupled to the inlet, the hose may define a vacuum hose. The vacuum hose can be used to vacuum dirt and grime from the interior or exterior of the vehicle. When coupled to the outlet, the hose may define a blowing hose. The blowing hose can be used to dry the vehicle. A power supply is attached to the housing and is electrically coupled to the pressure washer unit and the blower unit.

There has thus been outlined, rather broadly, the more important features of the disclosure in order that the detailed description thereof that follows may be better understood, and in order that the present contribution to the art may be better appreciated. There are additional features of the disclosure that will be described hereinafter, and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a vehicle washing assembly according to an embodiment of the disclosure.

FIG. 2 is a rear view of an embodiment of the disclosure.

FIG. 3 is a side view of an embodiment of the disclosure.

FIG. 4 is a side view of an embodiment of the disclosure.

### DETAILED DESCRIPTION OF THE INVENTION

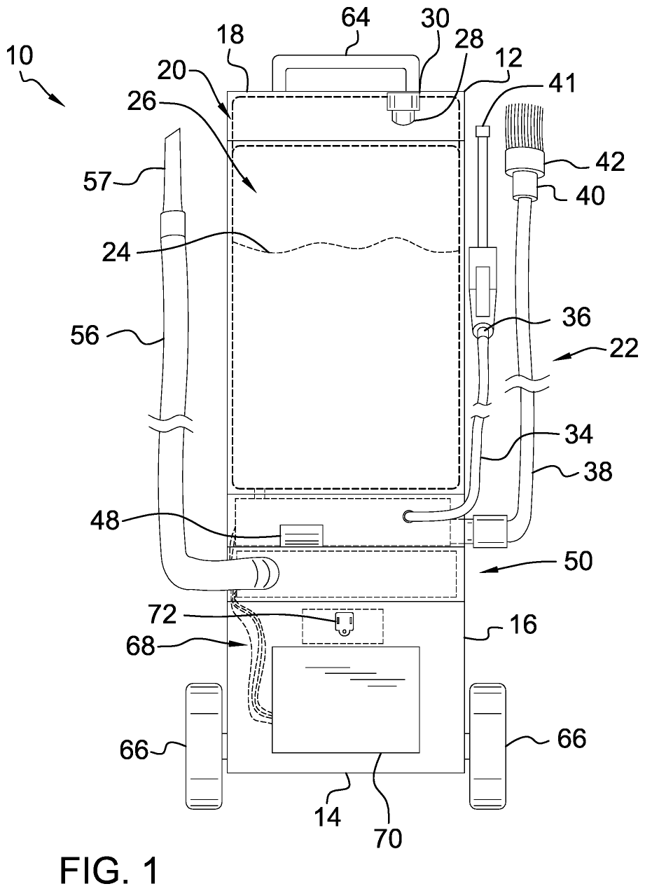

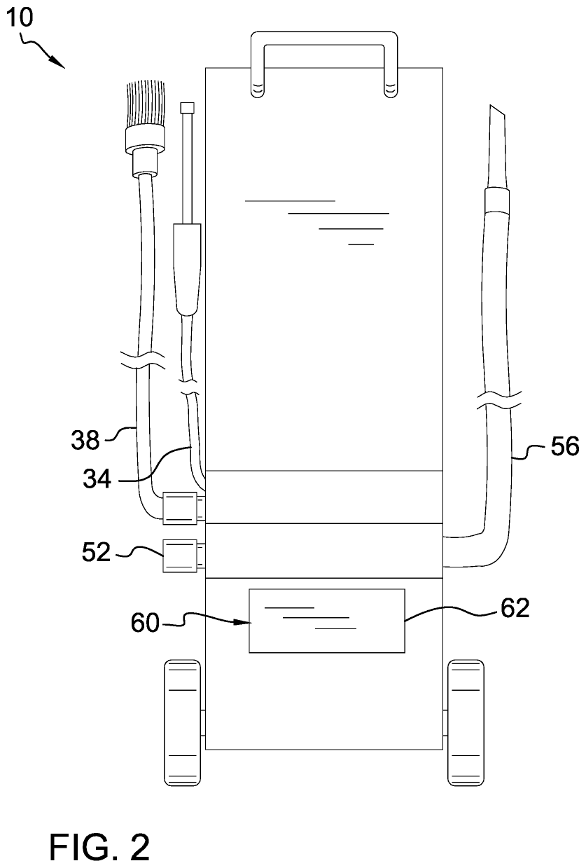

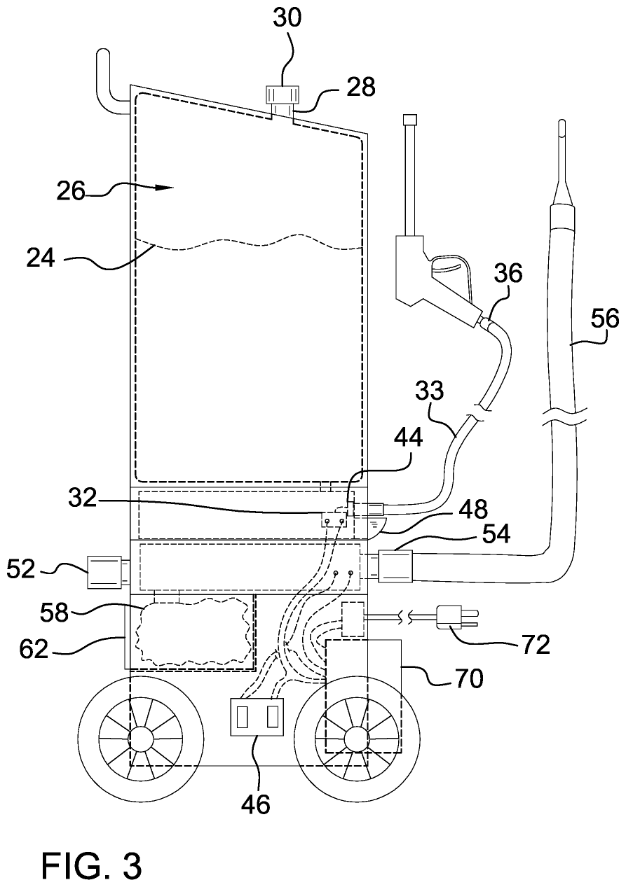

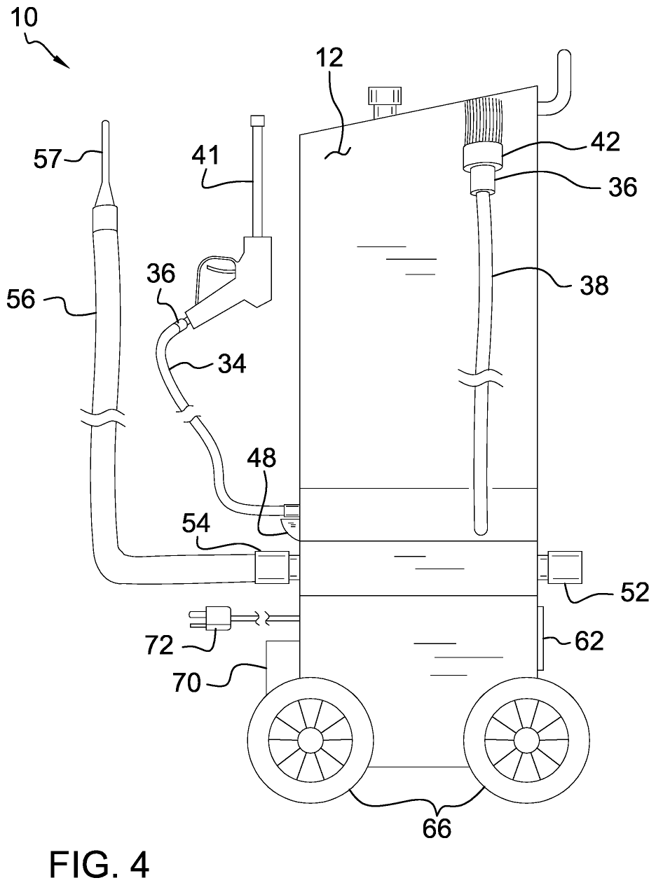

With reference now to the drawings, and in particular to FIGS. 1 through 4 thereof, a new car wash device embodying the principles and concepts of an embodiment of the disclosure and generally designated by the reference numeral 10 will be described.

As best illustrated in FIGS. 1 through 4, the vehicle washing assembly 10 generally comprises a housing 12 having a base wall 14. A peripheral wall 16 is attached to and extends upwardly from the base wall 14. A top wall 18 is attached to the peripheral wall 16 opposite the base wall 14. The peripheral wall 16 bounds an interior area 20.

A pressure washer unit 22 is mounted to the housing 12. The pressure washer unit 22 is configured to expel a fluid 24 under pressure in a selected direction. The pressure washer unit 22 can accordingly be used to wash dirt or grime from the vehicle.

Embodiments of the pressure washer unit 22 include a reservoir 26 that is positioned within the housing 12. The reservoir 26 holds the fluid 24 within the interior area 20. For example, the reservoir 26 may be located proximate to the top wall 18. In such embodiments, the reservoir 26 may be easily accessible to refill or add fluid 24 to the reservoir 26. Alternatively, the reservoir 26 may be located proximate to the base wall 14, or somewhere between the top wall 18 and the base wall 14.

A spout 28 is mounted to the housing 12. The spout 28 is in fluid communication with the reservoir 26. The fluid 24 may be added to the reservoir 26 through the spout 28. For example, particularly in embodiments where the reservoir 26 is located proximate to the top wall 18, the spout 28 may also be attached to the top wall 18. In embodiments where the reservoir 26 is located closer to the base wall 14, the spout 28 may also be located closer to the base wall 14. A cap 30 may be removably affixed to the spout 28, wherein the fluid 24 may be added to the reservoir 26 through the spout 28 when the cap 30 is removed from the spout 28.

A pump 32 is generally included in the pressure washer unit 22. The pump 32 is fluidly coupled to the reservoir 26 and is configured to pressurize the fluid 24. The pump 32 may be an electric pump or may be coupled to an electrically powered motor. In other embodiments, the pump 32 may be coupled to a gas-powered motor. Embodiments including a gas-powered motor would pressurize the fluid 24 more than embodiments including an electrically motorized pump 32. Thus, an electrically motorized or powered pump 32 may be preferred to ensure the fluid 24 is optimally pressurized for removing dirt or grime from the vehicle without damaging the paint or other surfaces of the vehicle.

A high-pressure hose 34 may be mounted on the housing 12. The high-pressure hose 34 is in fluid communication with the pump 32 for directing the fluid 24 when the fluid 24 is pressurized. A high-pressure nozzle 36 is coupled to the high-pressure hose 34. The high-pressure nozzle 36 dispenses the fluid 24 under a high pressure.

A low-pressure hose 38 may also be mounted on the housing 12 in fluid communication with the pump 32 for directing the fluid 24 when the fluid 24 is pressurized. A low-pressure nozzle 40 is coupled to the low-pressure hose 38 for dispensing the fluid 24 under a pressure less than the high pressure. A brush head 42 may be coupled to or attachable to the low-pressure nozzle 40. In some embodiments, the brush head 42 may be movably coupled to the low-pressure nozzle 40, such that the brush head 42 can pivot, swivel, or rotate around the low-pressure nozzle 40, thereby improving the ability of the brush head 42 to scrub different surfaces of the vehicle and to remove dirt or grime from the vehicle.

The high pressure at which the high-pressure nozzle 36 dispenses the fluid 24 and the pressure that is less than the high pressure at which the low-pressure nozzle 40 dispenses the fluid 24 are relative terms. In embodiments, the high-pressure nozzle 36 dispenses the fluid 42 at a higher pressure than the low-pressure nozzle 40 does. For example, with an electric pump 32, the high-pressure nozzle 36 may dispense the fluid 24 at a pressure of between approximately 1,300.0 psi and 1,700.0 psi. With a gas-powered pump 32, the high-pressure nozzle 36 may dispense the fluid 24 at a pressure of between approximately 2,000.0 psi and 2,800.0 psi. To reduce the risk of damaging the clear coat or the paint of the vehicle, the high-pressure nozzle 36 may be configured to dispense the fluid 24 at a pressure of between approximately 1,200.0 psi and 1,900.0 psi. The high-pressure nozzle 36 thereby enables the vehicle washing assembly 10 to break up tough substances or soils that may have adhered to the vehicle, such as road grime, bird droppings, bugs, tree sap, or caked on mud. The low-pressure nozzle 38 is generally configured to dispense the fluid 24 at a much lower pressure, for example between approximately 40.0 psi and 60.0 psi. With the low-pressure nozzle 38, the cleaning device can be used to apply cleaning solution while scrubbing the surface of the vehicle with the brush head 42. The low-pressure nozzle 38 can also be used to rinse the vehicle after washing.

A valve 44 may be in fluid communication with the pump 32, the high-pressure hose 34 and the low-pressure hose 36. The valve 44 is configured to alternately restrict and permit the fluid 24 from flowing through the high-pressure hose 34 or the low-pressure hose 38.

A switch 46 is positioned on the housing 12 and is operationally coupled to the valve 44. The switch 46 actuates the valve 44 to open either the high-pressure hose 34 or the low-pressure hose 38 relative to the pump 32. The switch 46 could be an electronic switch or could be manually toggled.

In other embodiments, the pressure washer unit 22 may include a single washing hose 33, rather than the separate high-pressure hose 34 and low-pressure hose 38. In such embodiments, the high-pressure nozzle 36 and the low-pressure nozzle 38 could be alternately coupled to the washing hose 33. The washing hose 33 is coupled to the valve 44, thereby enabling the switch 46 to actuate the valve 44 to open the washing hose 33 relative to the pump 32. Such embodiments may also include a pressure washer gun 41 that is couplable to the high-pressure nozzle 36. For example, the pressure washer gun 41 may be removably or permanently coupled to the high-pressure nozzle 36 for precisely controlling the direction in which the pressurized fluid is expelled. The brush head 42 may be removably or permanently coupled to the low-pressure nozzle 40, for example for scrubbing the vehicle while expelling a soapy washing solution or for expelling a rinsing fluid such as water.

A soap receptacle 48 may also be attached to the housing 12. The soap receptacle 48 is in fluid communication with the reservoir 26. The soap receptacle 48 is configured to dispense a cleansing solution into the reservoir 26, thereby mixing the cleansing solution with the fluid 24 to form a washing solution. Some embodiments of the soap receptacle 48 may extend outwardly from the peripheral wall 16, while others may be housed within the interior area 20, for example being accessible through a doorway or an additional spout.

A blower unit 50 is mounted to the housing 12. The blower unit 50 is configured to suction air inwardly through an inlet 52 and to blow air outwardly through an outlet 54. The inlet 52 and the outlet 54 are both mounted to the housing 12. For example, the inlet 52 and the outlet 54 may be positioned on the peripheral wall 16.

A hose 56 can be fluidly coupled to the inlet 52 to define a vacuum hose. The vacuum hose can be used to suction dirt or grime into the interior area 20. The hose 56 can also be or being fluidly coupled to the outlet 54 to define a blowing hose. The blowing hose can be used to expel air under pressure in a selected direction. For example, the blowing hose can be used to remove moisture or water from the vehicle, thereby drying the vehicle after it is washed with the pressure washer unit 22. In some embodiments, the vacuum hose and the blowing hose are separate and distinct hoses. In other embodiments, the vehicle washing assembly 10 may use a single hose 56 that can be alternately coupled to either the inlet 52 or the outlet 54 to alternately perform the functions of the vacuum hose and the blowing hose.

A nozzle 57 may be couplable to the hose 56. For example, the nozzle 57 may comprise a plurality of attachments being configured to extend the length of the hose 56 or being configured to provide additional utility to the hose 56. The attachments may include dusting brushes, crevice tools, extension wands, upholstery tools, or diffusers, thereby enabling the vehicle washing assembly 10 to clean every interior and exterior surface of the vehicle.

A catch 58 is in fluid communication with the inlet 52 for capturing debris suctioned in through the inlet 52. The peripheral wall 16 may have a doorway 60 that is formed therein. The doorway 60 permits access to the catch 58, for example to remove debris from the catch 58. A door 62 may be pivotably attached to the peripheral wall 16, opening and closing across the doorway 60.

A handle 64 may be attached to the housing 12. For example, the handle 64 may extend outwardly from the peripheral wall 16 proximate to the top wall 18. The handle 64 enables movement and portability of the vehicle washing assembly 10 to different locations, for example where a user may desire to clean the vehicle or store the vehicle washing assembly 10. A plurality of wheels 66 may be rotatably mounted under the base wall 14, thereby enabling the housing 12 to roll along a surface between locations. With these features, the user can move the vehicle washing assembly 10 to any location where it is desired or convenient to wash the vehicle or store the vehicle washing assembly 10.

A power supply 68 is attached to the housing 12. The power supply 68 is electrically coupled to the pressure washer unit 22 and the blower unit 50. In some embodiments, the power supply 68 may be positioned proximate to the base wall 14. Embodiments of the power supply 68 may include a rechargeable battery 70 that is removably mounted to the peripheral wall 16 such that the rechargeable battery 70 is accessible from an exterior of the peripheral wall 16. Embodiments of the power supply 68 may also include a power plug 72 that is operably coupled with the power supply 68. The power plug 72 may extend outwardly from the peripheral wall 16 and is configured for removable insertion into an alternating current power outlet.

In use, the pressure washer unit 22 can be used to wash and rinse the vehicle. The blower unit 50 can be used to vacuum and dry the vehicle. With the vehicle washing assembly 10, the user can completely clean the vehicle using a single machine.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. A cleaning device comprising:
a housing having a base wall, a peripheral wall being attached to and extending upwardly from the base wall, and a top wall being attached to the peripheral wall opposite the base wall, the peripheral wall bounding an interior area;
a pressure washer unit being mounted to the housing, the pressure washer unit being configured to expel a fluid under pressure in a selected direction;
a blower unit being mounted to the housing, the blower unit being configured to suction air inwardly through an inlet and to blow air outwardly through an outlet, the inlet and the outlet being mounted to the housing;
a catch being in fluid communication with the inlet for capturing debris suctioned in through the inlet; and
a power supply being attached to the housing, the power supply being electrically coupled to the pressure washer unit and the blower unit.

2. The cleaning device of claim 1, the pressure washer unit further comprising:
a reservoir being positioned within the housing, the reservoir holding the fluid within the interior area;
a pump being fluidly coupled to the reservoir, the pump being configured to pressurize the fluid;
a washing hose being mounted on the housing and being in fluid communication with the pump for directing the fluid when the fluid is pressurized;
a valve being in fluid communication with the pump and the hose assembly, the valve being configured to alternately restrict and permit the fluid from flowing through the hose assembly; and
a switch being positioned on the housing and being operationally coupled to the valve, the switch actuating the valve to open the hose assembly relative to the pump.

3. The cleaning device of claim 2, the washing hose further comprising:
a high-pressure hose being mounted on the housing and being in fluid communication with the pump for directing the fluid when the fluid is pressurized; and
a high-pressure nozzle being coupled to the high-pressure hose, the high-pressure nozzle dispensing the fluid under a high pressure.

4. The cleaning device of claim 3, the washing hose further comprising:
a low-pressure hose being mounted on the housing and being in fluid communication with the pump for directing the fluid when the fluid is pressurized;
a low-pressure nozzle being coupled to the low-pressure hose for dispensing the fluid under a pressure less than the high pressure; and
a brush head being attached to the low-pressure nozzle.

5. The cleaning device of claim 2, the washing hose further comprising:
a high-pressure nozzle being couplable to the washing hose, the high-pressure nozzle dispensing the fluid under a high pressure;
a pressure washer gun being attachable to the high-pressure nozzle;
a low-pressure nozzle being couplable to the washing hose for dispensing the fluid under a pressure less than the high pressure; and
a brush head being attachable to the low-pressure nozzle.

6. The cleaning device of claim 1, the pressure washer unit further comprising:
a spout being attached to the housing, the spout being in fluid communication with the reservoir; and
a cap being removably coupled to the spout, wherein the fluid may be added to the reservoir through the spout when the cap is removed from the spout.

7. The cleaning device of claim 1, the pressure washer unit further comprising a soap receptacle being attached to the housing, the soap receptacle being in fluid communication with the reservoir, the soap receptacle being configured to dispense a cleansing solution into the reservoir, thereby mixing the cleansing solution with the fluid to form a washing solution.

8. The cleaning device of claim 1, further comprising:
the peripheral wall having a doorway being formed therein, the doorway permitting access to the catch; and
a door being pivotably attached to the peripheral wall, the door opening and closing across the doorway.

9. The cleaning device of claim 1, further comprising a hose being fluidly coupled to the inlet to define a vacuum hose or being fluidly coupled to the outlet to define a blowing hose.

10. The cleaning device of claim 1, further comprising a handle being attached to the housing, the handle extending outwardly from the peripheral wall proximate to the top wall.

11. The cleaning device of claim 1, further comprising a plurality of wheels being rotatably mounted under the base wall, thereby enabling the housing to roll along a surface.

12. The cleaning device of claim 1, the power supply further comprising a rechargeable battery being removably mounted to the peripheral wall such that the rechargeable battery is accessible from an exterior of the peripheral wall.

13. The cleaning device of claim 1, the power supply further comprising a power plug being operably coupled with the power supply, the power plug extending outwardly from the peripheral wall and being configured for removable insertion into an alternating current power outlet.

14. A portable vehicle cleaning device, comprising:
a housing having a base wall, a peripheral wall being attached to and extending upwardly from the base wall, and a top wall being attached to the peripheral wall opposite the base wall, the peripheral wall bounding an interior area;
a pressure washer unit being mounted to the housing, the pressure washer unit being configured to expel a fluid under pressure in a selected direction, the pressure washer unit including:
a reservoir being positioned within the housing, the reservoir holding the fluid within the interior area, the reservoir being located proximate to the top wall;
a spout being attached to the top wall, the spout being in fluid communication with the reservoir;
a cap being removably affixed to the spout, wherein the fluid may be added to the reservoir through the spout when the cap is removed from the spout;
a pump being fluidly coupled to the reservoir, the pump being configured to pressurize the fluid;
a high-pressure hose being mounted on the housing and being in fluid communication with the pump for directing the fluid when the fluid is pressurized;
a high-pressure nozzle being attached to the high-pressure hose, the high-pressure nozzle dispensing the fluid under a high pressure;
a low-pressure hose being mounted on the housing and being in fluid communication with the pump for directing the fluid when the fluid is pressurized;
a low-pressure nozzle being attached to the low-pressure hose for dispensing the fluid under a pressure less than the high pressure;
a brush head being attached to the low-pressure nozzle;
a valve being in fluid communication with the pump, the high-pressure hose and the low-pressure hose, the valve being configured to alternately restrict and permit the fluid from flowing through the high-pressure hose or the low-pressure hose;
a switch being positioned on the housing and being operationally coupled to the valve, the switch actuating the valve to open either the high-pressure hose or the low-pressure hose relative to the pump;
a soap receptacle being attached to the housing, the soap receptacle being in fluid communication with the reservoir, the soap receptacle being configured to dispense a cleansing solution into the reservoir, thereby mixing the cleansing solution with the fluid to form a washing solution, the soap receptacle extending outwardly from the peripheral wall;
a blower unit being mounted to the housing, the blower unit being configured to suction air inwardly through an inlet and to blow air outwardly through an outlet, the inlet and the outlet being mounted to the housing;
a hose being fluidly coupled to the inlet to define a vacuum hose or being fluidly coupled to the outlet to define a blowing hose;
a catch being in fluid communication with the inlet for capturing debris suctioned in through the inlet;
the peripheral wall having a doorway being formed therein, the doorway permitting access to the catch;
a door being pivotably attached to the peripheral wall, the door opening and closing across the doorway;
a handle being attached to the housing, the handle extending outwardly from the peripheral wall proximate to the top wall;
a plurality of wheels being rotatably mounted under the base wall, thereby enabling the housing to roll along a surface;
a power supply being attached to the housing, the power supply being electrically coupled to the pressure washer unit and the blower unit, the power supply being positioned proximate to the base wall, the power supply including:
a rechargeable battery being removably mounted to the peripheral wall such that the rechargeable battery is accessible from an exterior of the peripheral wall; and
a power plug being operably coupled with the power supply, the power plug extending outwardly from the peripheral wall and being configured for removable insertion into an alternating current power outlet.
